(19) United States
(12) Patent Application Publication
(10) Pub. No.: US 2009/0255154 A1
(43) Pub. Date: Oct. 15, 2009

(54) Framable Greeting Card Arrangement

(76) Inventor: Deborah A. Roppo, Baden, PA (US)

Correspondence Address: THE WEBB LAW FIRM, P.C., 700 KOPPERS BUILDING, 436 SEVENTH AVENUE, PITTSBURGH, PA, 15219, US

(21) Appl. No.: 12/421,275

(22) Filed: Apr. 9, 2009

Related U.S. Application Data
(60) Provisional application No. 61/044,244, filed on Apr. 11, 2008.

(51) Int. Cl. G09F 1/04

(52) U.S. Cl. 40/124.11

(57) ABSTRACT

A greeting card which can be manipulated to more prominently display an image contained thereon is provided. The greeting card has a plurality of panels with a first panel containing an image and a second panel having a removable perforated section. Removing the perforated section creates a hole in the second panel and the first panel can be folded along a fold edge so that at least a portion of the image is visible through the hole in the second panel with a front face of the second panel acting to frame the image. The card may further contain a third panel which may have an easel projection for supporting the card is a display position on a flat surface.

### CROSS REFERENCE TO RELATED APPLICATIONS

This application claims priority to U.S. Provisional Patent Application No. 61/044,244, filed on Apr. 11, 2008, the contents of which are expressly incorporated herein by reference.

### BACKGROUND OF THE INVENTION

1. Field of the Invention

The invention relates to greeting cards, and specifically to greeting cards that can be adapted to more prominently display the designs thereon.

2. Description of Related Art

Greeting cards have been used for many years as a means of conveying a message to the recipient, e.g., a wish of “Happy Birthday,” an offer of condolences for a recent loss, etc. Generally, a greeting card consists of nothing more than a flat sheet of thick paper, such as stock or construction paper, folded in half, with a message or design on the front of the card and another message or design inside the card.

However, despite their relative simplicity, new and improved greeting cards continually surface. Examples of such innovation include musical greeting cards, as depicted in U.S. Pat. No. 7,152,350 (Youngdahl), greeting cards with scanable gift certificates, such as in U.S. Pat. No. 7,024,807 (Street), greeting cards featuring a money pocket and adhesive, as in U.S. Pat. No. 6,148,550 (Niedfeld), and greeting cards with a gift holder on a front surface, such as in U.S. Pat. No. 7,222,446 (Foster).

As the greeting card industry continues to prosper, there continues to be a need for further innovations in the art.

### SUMMARY OF THE INVENTION

The present invention is directed to a greeting card that can be easily and readily manipulated so that the image or artwork disposed on, for example, the front face of the card is framed or bordered.

In one aspect of the invention, the greeting card contains a first panel having a front face with an image thereon and a back face disposed opposite the front face, a second panel connected to the first panel along the length of a fold edge separating the first panel and the second panel, the second panel having a front face, a back face disposed opposite the front face, and a removable perforated section, and at least one adhesive portion, wherein the first panel is operable to be adjusted to a folded position such that the front face of the first panel substantially faces the back face of the second panel.

In some non-limiting embodiments, the adhesive portion(s) may be adapted to maintain the front face of the first panel in a position substantially facing the back face of the second panel. The adhesive portion(s) may be provided on the front face of the first panel and/or on the back face of the second panel. The adhesive portions may be in the form of adhesive strips.

In another aspect of the invention, the greeting card contains a first panel including a front face and a back face disposed opposite the front face, the front face having an image thereon, a second panel connected to the first panel along the length of a fold edge separating the first panel and the second panel, the second panel having a front face, a back face disposed opposite the front face, and a removable perforated section, and a third panel having a front face and a back face disposed opposite the front face, wherein the first panel is operable to be adjusted to a folded position such that the front face of the first panel substantially faces the back face of the second panel.

In some non-limiting embodiments, the third panel may include a pivotable easel portion, and the pivotable easel portion may include at least one perforated section.

In some non-limiting embodiments, the third panel can be connected to the second panel along the length of a second fold edge separating the second panel from the third panel, and the third panel can be operable so as to be adjusted to a folded position such that the front face of the third panel substantially faces the back face of the first panel.

In some non-limiting embodiments, the greeting card can also include at least one adhesive portion, and the adhesive portion(s) can be adapted to maintain the front face of the first panel in a position substantially facing the back face of the second panel. Additionally, the adhesive portion(s) can maintain the front face of the third panel in a position substantially facing the back face of the first panel. In some non-limiting embodiments, the adhesive portion(s) can be provided on one or more of the back face of the first panel and the third panel, such as on the front face of the third panel.

In another aspect of the invention, the invention is directed to a manipulated greeting card. The manipulated greeting card can include a first panel having a front face with an image printed thereon and a back face disposed opposite the front face, a second panel connected to the first panel along the length of a fold edge, the second panel comprising a front face, a back face disposed opposite the front face, and a hole therethrough wherein the back face of the second panel substantially faces the front face of the first panel, and a third panel having a front face, a back face disposed opposite the front face. At least a portion of the image printed on the front face of the first panel is visible through the hole in the second panel. The third panel may be connected to the second panel along the length of a second fold edge that separates the second panel from the third panel

In some non-limiting embodiments, the manipulated greeting card can further include an easel portion extending from the third panel, wherein the easel portion can be adapted to support the greeting card in an upright position.

In some non-limiting embodiments, the manipulated greeting card can further include at least one adhesive portion(s) adapted to secure the back face of the second panel in a position substantially facing the front face of the first panel and/or the adhesive portion(s) may be adapted to secure the front face of the third panel in a position substantially facing the back face of the first panel.

The greeting cards of the instant invention can be manipulated to more prominently display the image contained on the front side of the first panel. More specifically, a removable perforated shape can be removed and the card manipulated so that a portion of the first panel, preferably that portion containing the image, is visible through the void left by removal of the perforated shape. In this way, the second panel can “frame” the image. The greeting card may be placed in a picture frame or affixed to a wall or refrigerator for display. In certain non-limiting embodiment, an easel projects from a third panel of the greeting card allowing for the card to be positioned in the upright position on a surface without any extraneous structural support.

These and other features and characteristics of the present invention, as well as the methods of operation and functions of the related elements of structures and the combination of parts and economies of manufacture, will become more apparent upon consideration of the following description with reference to the accompanying drawings, which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a perspective view of a framable greeting card according to one embodiment.

FIG. 2 is a plan view of one side of the greeting card of FIG. 1 laid flat.

FIG. 3 is a plan view of the other side of the greeting card of FIGS. 1 and 2 laid flat.

FIG. 4 is a plan view of one panel of the greeting card of FIGS. 1-3 showing a preferred easel shape.

FIG. 5 is a perspective view of the framable greeting card according to another embodiment.

FIG. 6 is a plan view of one side of the framable greeting card of FIG. 5 laid flat.

FIG. 7 is a plan view of the other side of the framable greeting card of FIGS. 5 and 6 laid flat.

FIG. 8 is a perspective view of the framable greeting card according to another embodiment.

FIG. 9 is a perspective view of the greeting card of FIG. 8.

FIG. 10 is a plan view of one side of the framable greeting card according to another embodiment.

FIG. 11 is a plan view of the other side of the framable greeting card of FIG. 10.

FIG. 12 is a plan view of the framable greeting card of FIGS. 10-11 after the card has been manipulated into the framed orientation.

### DESCRIPTION OF THE PREFERRED EMBODIMENTS

The present application is directed to a greeting card, and more particularly to a greeting card that can be manipulated so as to more elegantly display the artwork or design features contained thereon.

The greeting card of the instant invention is preferably made of a material conventionally used for greeting cards, such as cardboard, paper stock, plastic or the like, although other material may be used without departing from the spirit of the present invention. The greeting card can take on any shape or dimension, but preferably is dimensioned so as to fit in standard square or rectangular envelopes for sending the greeting card through the mail. In addition, the greeting card of the instant invention may also be dimensioned so as to fit in standard picture frames, such as picture frames that are 5″×7″ or 4″×6″.

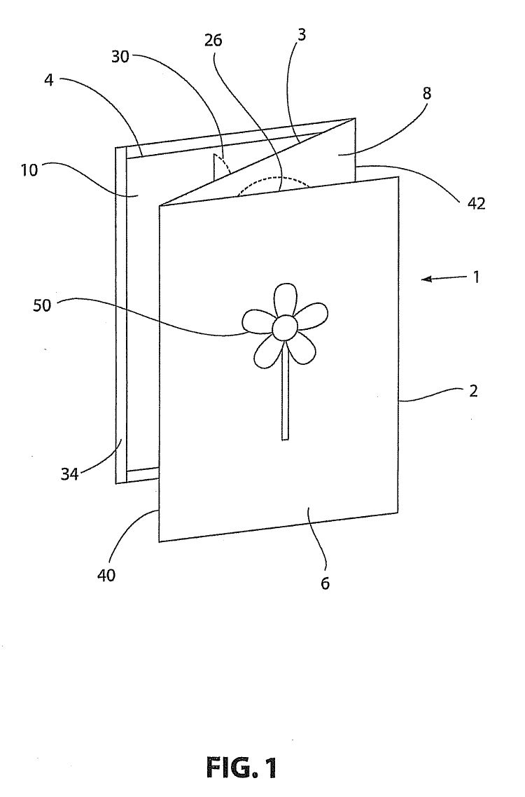

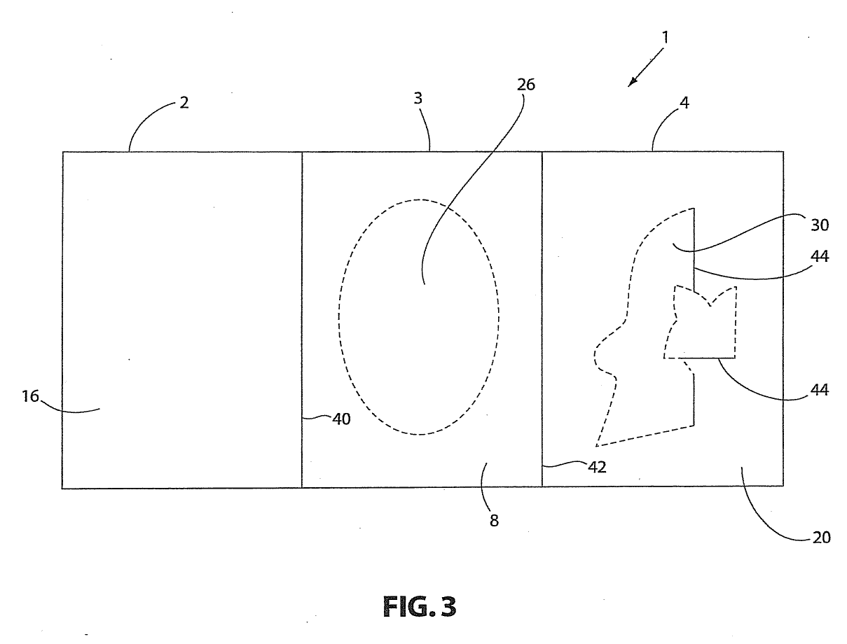

A first embodiment of the framable greeting card is indicated generally by the numeral 1 and is particularly shown in FIGS. 1-3. In this embodiment, greeting card 1 comprises a front panel 2, a mat panel 3 and an easel panel 4. Front panel 2 is comprised of both a front face 6 and a back face 16. Mat panel 3 also has both a front face 8 and a back face 18. Likewise, easel panel 4 has a front face 10 and a back face 20.

Disposed on front face 6 of front panel 2 is an image 50, which may be a drawing, message, artwork, design, graphic, etc. For example, front face 6 of front panel 2 may display a message such as “HAPPY BIRTHDAY” or the like in conjunction with a picture or drawing. Preferably, the image 50 is centrally disposed on front face 6 of front panel 2, but other arrangements are also contemplated. Back face 16 of front panel 2 can be left blank, allowing the user to inscribe a personalized message thereon, or back face 16 of front panel 2 can contain additional pre-printed drawings and/or messages.

Mat panel 3 contains a removable perforated section, such as punch-out shape 26, which can be formed by perforating mat panel 3 using any technique known in the art. Punch-out shape 26 should be formed to allow a user to easily partially or completely remove or separate punch-out shape 26 from mat panel 3 using only his or her fingers. After punch-out shape 26 has been removed, mat panel 3 will have a void or hole therein which corresponds to the dimensions of punch-out shape 26. Front face 8 of mat panel 3 can have disposed thereon a message or drawing. For example, front face 8 of mat panel 3 can contain a message such as “Wishing you a very Happy Birthday!” so that, once front panel 2 is opened by pivoting it about front panel fold edge 40, the message contained on front face 8 of mat panel 3 is displayed to the person holding the card. The message appearing on front face 8 of mat panel 3 can be disposed so as to overlap onto punch-out shape 26, or it can be disposed entirely outside of the area defining punch-out shape 26. As another option, the message can be fully contained within the area defining punch-out shape 26. In one arrangement, the area immediately surrounding punch-out shape 26 is decorated to accentuate image 50 which appears on front face 6 of front panel 2, the advantages of which will become apparent below. Back face 18 of mat panel 3 is preferably blank but may optionally contain drawings and/or text.

Punch-out shape 26 can be in the form of any shape, such as a square, rectangle, circle, oval, etc. As will be further understood from the discussion which follows, punch-out shape 26 will define the dimensions of a frame through which image 50 on front face 6 of front panel 2 will be viewed. Consequently, the dimensions of punch-out shape 26 should be slightly larger than the image 50 disposed on front face 6 of front panel 2 that the user intends to display.

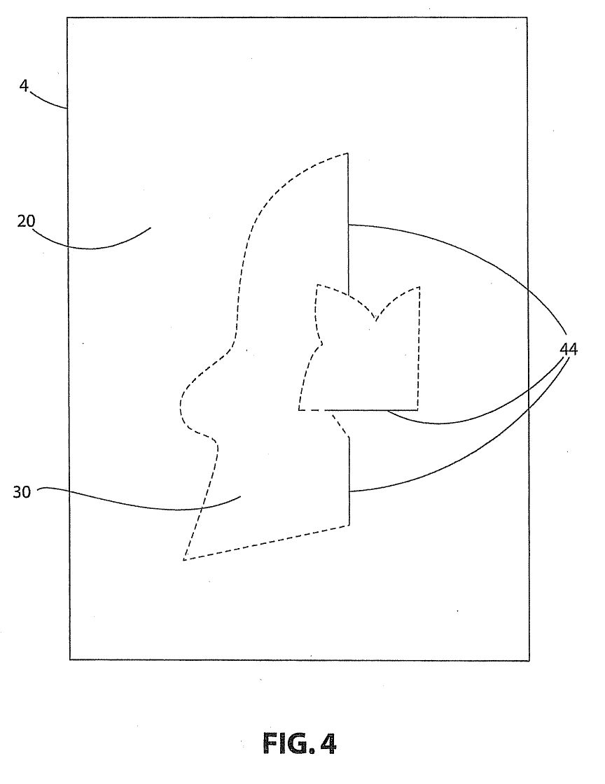

Easel panel 4 contains an easel 30 which, like punch-out shape 26, can also be formed by perforating certain lines or portions defining the easel panel 4 using any technique known in the art. However, easel 30 should not be fully perforated, but instead a portion of easel 30 should remain intact with easel panel 4, since easel 30, unlike punch-out shape 26, is not fully removable from greeting card 1. Easel 30 provides the necessary structure for greeting card 1 to be displayed in a relatively vertical direction on, for example, a table or other flat surface. One example of a configuration of easel 30, as it appears on easel panel 4 prior to being partially separated therefrom, is shown in FIG. 4. In FIG. 4, the dotted line segment represents the perforated portion of easel panel 4, while the solid line segment represents easel pivot line 44.

Easel panel 4 may also contain one or more adhesive strips 34, preferably disposed on front face 10 of easel panel 4. Adhesive strips 34 may be composed of, for example, a pressure-sensitive, self-adhesive material with a backing paper. Peel-and-stick or double-sided tape products usable for such purpose are generally known in the art. After the backing paper has been removed, a self-adhesive material can form a bond without the need for solvent, water, or heat by contacting the adhesive strip 34 with a surface and applying pressure. Adhesive strips 34 may alternatively be composed of a water-activated adhesive material which requires the user to moisten adhesive strips 34 before forming a bond. Such water-activated adhesives are readily known in the art, an example of which is LICK & STICK remoistenable envelope glue, available commercially from Green Sneakers, Inc.

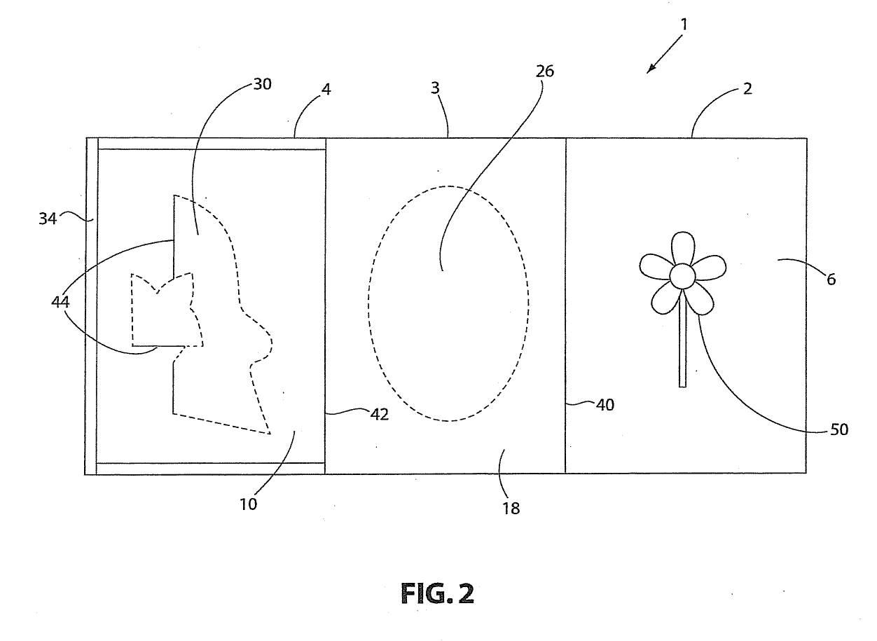

Operation of this first embodiment of greeting card 1 will now be described with all spatial and directional terms relating to the invention as it is shown in FIG. 2. First, punch-out shape 26 is removed by applying pressure to the perforated surface of mat panel 3. Once removed, a void will exist in mat panel 3 which corresponds to the dimensions of punch-out shape 26. Next, easel 30 is prepared for use by applying pressure to the perforated portion thereof and pivoting easel 30 along easel pivot line 44. Easel 30 should be pivoted so that it protrudes from the back face 20 of easel panel 4 rather than from the front face 10 of easel panel 4. Next, adhesive strips 34 should be adapted so that they can bond upon contact with another surface. If a pressure-sensitive, self-stick adhesive is used for adhesive strips 34, this requires removal of the backing paper. If a water-activated adhesive is used for adhesive strips 34, water should be applied to the adhesive material. Front panel 2 can now be pivoted about front panel fold edge 40 so that front face 6 of front panel 2 contacts back face 18 of mat panel 3. It should be noted that each of the aforementioned steps can be performed in any order and the discussion above merely represents one method.

Next, easel panel 4 is pivoted about mat panel fold edge 42 so that front face 10 of easel panel 4 substantially faces or comes into contact with back face 16 of front panel 2. Because adhesive strips 34 have been prepped for bonding, contacting front face 10 of easel panel 4 with back face 16 of front panel 2 causes front face 10 of easel panel 4 to adhere to back face 16 of front panel 2. Greeting card 1 can now be placed on a table or other surface for display with easel 30 acting to support greeting card I in the upright position. The image 50 disposed on front face 6 of front panel 2 can be viewed through the void left by removal of punch-out shape 26. The remaining portion of front face 8 of mat panel 3 frames the image 50 from front face 6 of front panel 2.

Alternatively, the step of removing easel 30 from easel panel 4 can be disregarded and greeting card 1, without easel 30 protruding therefrom, can be inserted into a picture frame for display, or hung on a wall, refrigerator, etc.

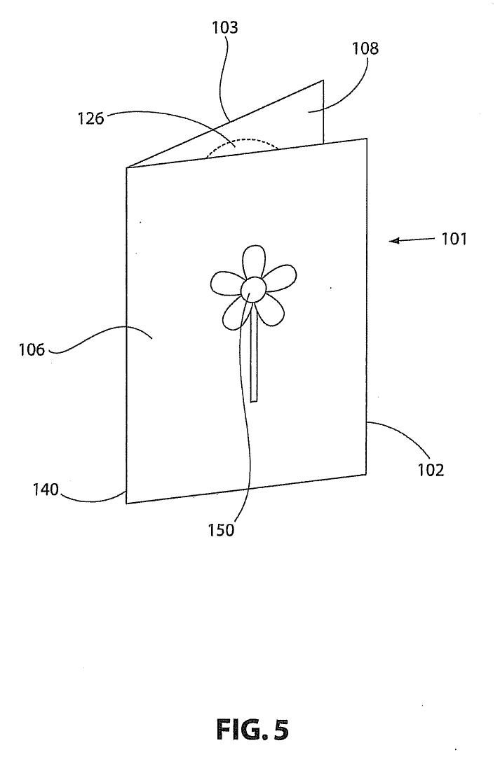

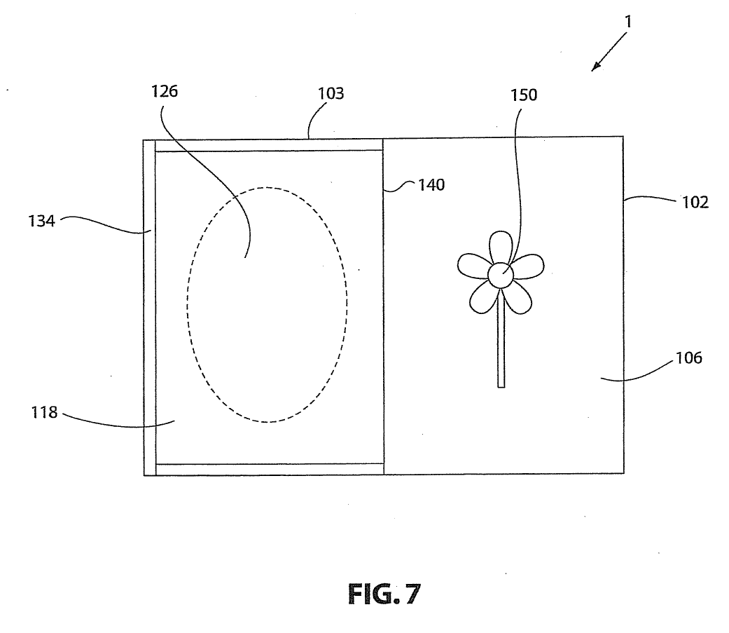

A second embodiment of the framable greeting card is indicated generally by the numeral 101 and is shown in FIGS. 5-7. In this embodiment, greeting card 101 comprises a front panel 102 and a mat panel 103 separated by fold edge 140. Front panel 102 is comprised of both a front face 106 and a back face 116. Mat panel 103 also has both a front face 108 and a back face 118.

As with the first embodiment described above, front face 106 of front panel 102 may have disposed thereon an image 150, such as a drawing, message, artwork, design, graphic, etc. As one example, image 150 could include the message “HAPPY BIRTHDAY”. Preferably, image 150 is centrally disposed on front face 106 of front panel 102, but other arrangements are also contemplated. Back face 116 of front panel 102 can be left blank, allowing for the user to inscribe a personalized message thereon, or may contain additional drawings and/or messages.

Mat panel 103 contains a punch-out shape 126 which can be formed by perforating mat panel 103 using any technique known in the art. Punch-out shape 126 should be formed to allow a user to easily remove punch-out shape 126 using his or her fingers. After punch-out shape 126 has been removed, mat panel 103 will have a void or hole therein which corresponds to the dimensions of punch-out shape 126. Front face 108 of mat panel 103 can have disposed thereon a message or drawing and the message can overlap onto punch-out shape 126, be entirely outside of the area defined by punch-out shape 126, or be fully contained within the area defined by punch-out shape 126. In one arrangement, the area immediately surrounding punch-out shape 126 is decorated to accentuate image 150 which appears on front face 106 of front panel 102.

Back face 118 of mat panel 103 may contain at least one adhesive strip 134. Adhesive strips 134 may be composed of any suitable adhesive material known in the art including pressure-sensitive, self-stick adhesives or water-activated adhesives, as explained above with respect to adhesive strips 34. It is important that punch-out shape 126 is not dimensioned so as to overlap with adhesive strips 134 since this will impede one's ability to remove punch-out shape 126 from mat panel 103.

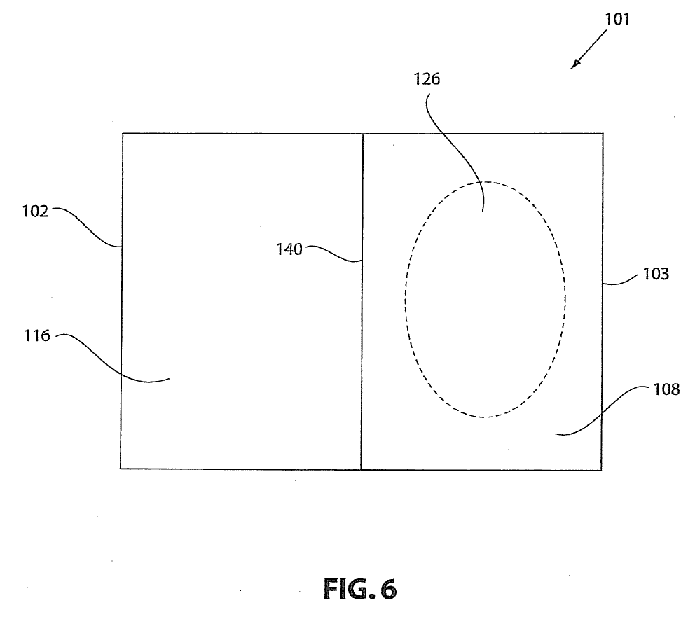

Operation of this second embodiment of greeting card 101 will now be described with all spatial and directional terms relating to the invention as it is shown in FIG. 6. Punch-out shape 126 is first removed by applying pressure to the perforated shape. Removal of punch-out shape 126 creates a hole in mat panel 103. After removal of punch-out shape 126, adhesive strips 134 are adapted so as to be ready to bond with another surface upon contact. If adhesive strips 134 are comprised of pressure-sensitive, self-adhesive with backing strips, the backing strips are removed. If adhesive strips 134 are comprised of a water-activated adhesive, water is applied to adhesive strips 134. When adhesive strips 134 are ready for bonding, front panel 102 is pivoted about fold edge 140 until front face 106 of front panel 102 contacts back face 118 of mat panel 103. Because adhesive strips 134 are present on back face 118 of mat panel 103, such contact creates a bond between adhesive strips 134 and front face 106 of front panel 102. The void left by removal of punch-out shape 126 creates a “frame” through which at least a portion of image 150 contained on front face 106 of front panel 102 is displayed. Greeting card 101 can now be placed into a picture frame and prominently displayed in one's home or office or affixed to a wall, refrigerator, etc. using thumbtacks, magnets, or any other appropriate attaching device.

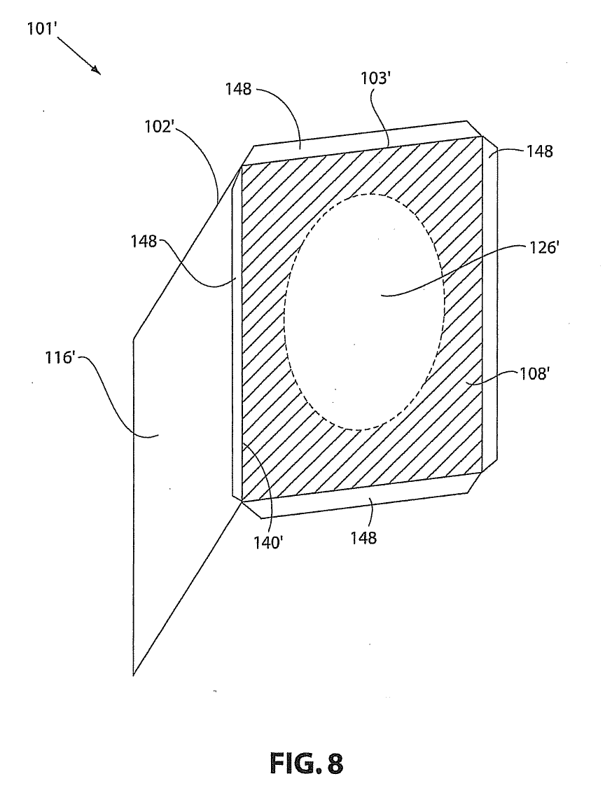

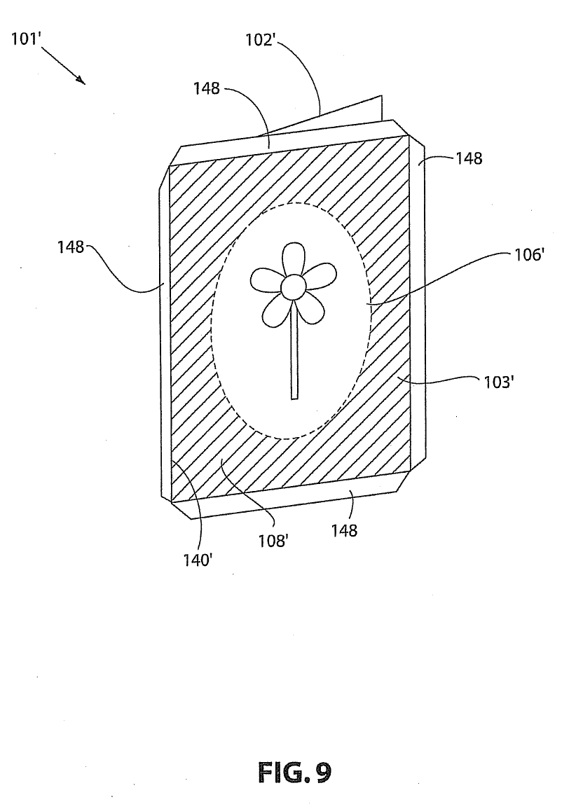

Another embodiment of the greeting card of the instant invention is indicated generally by numeral 101′ and is shown in FIGS. 8-10. In this embodiment, greeting card 101′ comprises a front panel 102′ and a mat panel 103′ separated by fold edge 140′. Front panel 102′ is comprised of both a front face 106′, on which is disposed an image 150′, such as a drawing, message, etc., and a back face 116′, which may be blank or contain a drawing, text, etc. Mat panel 103′ also has both a front face 108′ and a back face 118′. Mat panel 103′ further contains a punch-out shape 126′. Front face 108′ of mat panel 103′ may be designed according to any front face of mat panel described herein in reference to other embodiments.

Mat panel 103′ further contains at least one adhesive flap 148 preferably attached at or near an edge of mat panel 103′. Adhesive flaps 148 are generally flat strips having two sides with an adhesive material disposed on one side. The adhesive material can be a pressure-sensitive, self-adhesive and may be covered with backing paper. The non-adhesive side of adhesive flaps 148 can be comprised of polymer, paper, or any other suitable non-stick material. Adhesive flaps 148 are preferably disposed so that, when adhesive flaps 148 are fully extended from mat panel 103′, the adhesive sides of adhesive flaps 148 face opposite front side 108′ of mat panel 103′. The purpose of such orientation will become apparent below.

The operation of greeting card 101′ will now be described. Punch-out shape 126′ is removed by applying pressure to the perforated portion thereof, creating a void in mat panel 103′. Front panel 102′ is then pivoted about fold edge 140′ so that front face 106′ of front panel 102′ contacts back face 118′ of mat panel 103′. After positioning front face 106′ of front panel 102′ against back face 118′ of mat panel 103′, the backing paper can be removed from adhesive flaps 148 and adhesive flaps 148 can be wrapped over the edges of front panel 102′ and affixed to back face 116′ of front panel 102′. The void left by removal of punch-out shape 126′ creates a “frame” through which at least a portion of the image 150′ contained on front face 106′ of front panel 102′ is displayed. Greeting card 101′ can now be placed into a picture frame or affixed to a wall, refrigerator, etc. using thumbtacks, magnets, or any other appropriate attaching device.

Alternatively, adhesive flaps 148 can be disposed on front panel 102′ at a position at or near the edge of front panel 102′ with the adhesive side of adhesive flaps 148 facing opposite the front face 106′ of front panel 102′ when adhesive flaps 148 are in a fully extended position. In such an arrangement, after positioning front face 106′ of front panel 102′ against back face of mat panel 103′ with punch-out shape 126′ removed, the backing paper can be removed from adhesive flaps 148 and adhesive flaps 148 can be wrapped over the edges of mat panel 103′ and affixed to front face 108′ of mat panel 103′.

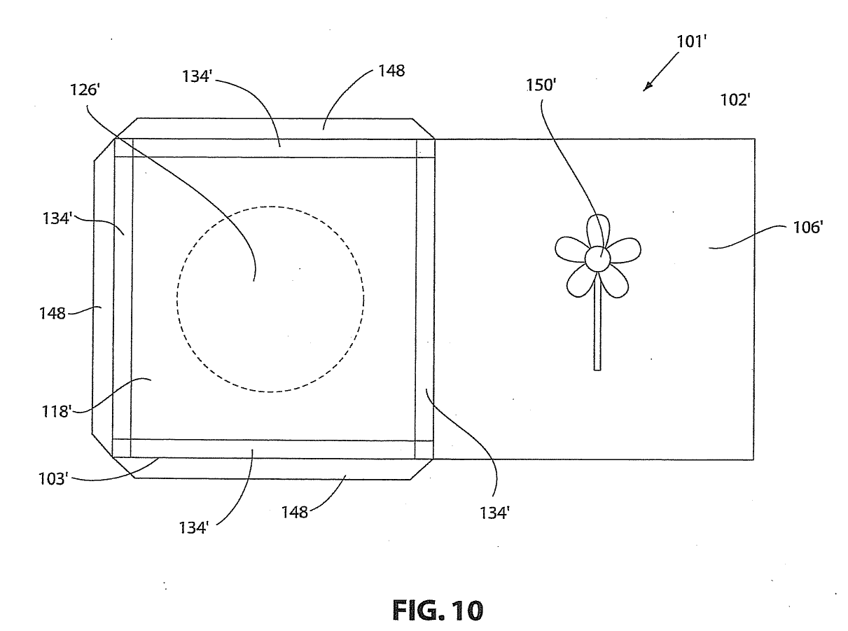

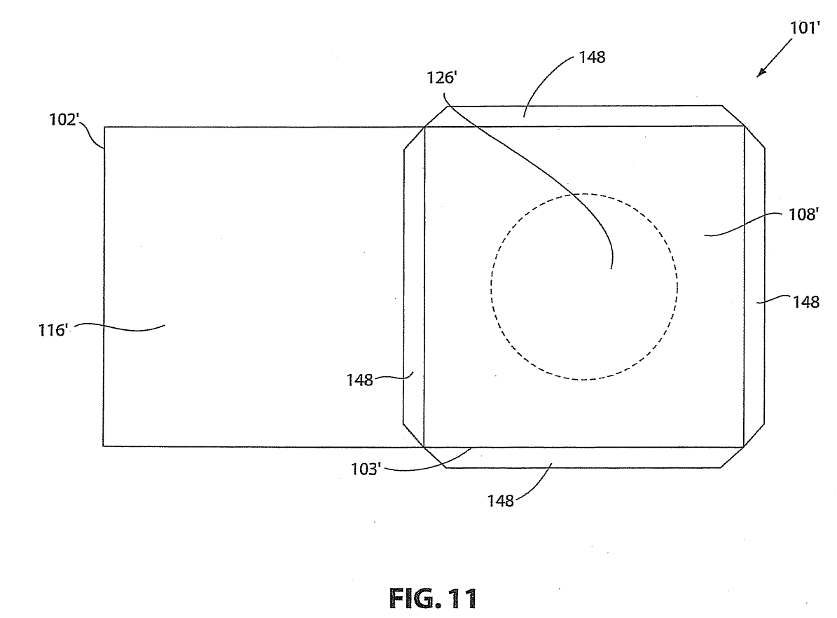

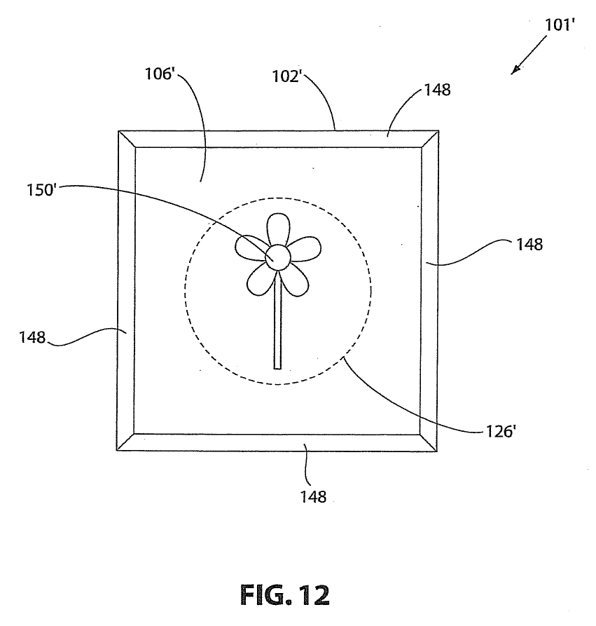

In yet another embodiment, shown in FIGS. 10-12, back face 118′ of mat panel 103′ can contain one or more adhesive strip 134′ and mat panel 103′ can contain one or more adhesive flaps 148 disposed at or near the edge of mat panel 103′. Adhesive strips 134′ can be composed of a material similar to that described with respect to adhesive strips 34 and 134 above. In this embodiment, adhesive flaps 148 are constructed so that, when adhesive flaps 148 are fully extended from mat panel 103′, the adhesive sides of adhesive flaps 148 face opposite back side 118′ of mat panel 103′.

Operation of this embodiment will now be described. Punch-out shape 126′ is removed by applying pressure to the perforated portion thereof, creating a void in mat panel 103′. Adhesive strips 134′ are then adapted so that they can bond upon contact with another surface. Front panel 102′ is then pivoted about fold edge 140′ so that front face 106′ of front panel 102′ contacts back face 118′ of mat panel 103′. Because adhesive strips 134′ are adapted for bonding, front face 106′ of front panel 102′ adheres to back face 118′ of mat panel 103′. After positioning front face 106′ of front panel 102′ against back face 118′ of mat panel 103′, adhesive flaps 148 can be adapted for bonding and adhesive flaps 148 can be affixed to front face 108′ of mat panel 103′ to create a “frame” around the edge of front face 106′ of front panel 102′. The void left by removal of punch-out shape 126′ creates a “mat” bounded by the “frame” through which at least a portion of the image 150′ contained on front face 106′ of front panel 102′ is displayed. Greeting card 101′ can now be placed into a physical picture frame or affixed to a wall, refrigerator, etc. using thumbtacks, magnets, or any other appropriate attaching device.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements. For example, it is to be understood that the present invention contemplates that, to the extent possible, one or more features of any embodiment can be combined with one or more features of any other embodiment.

What is claimed is:

1. A greeting card, comprising:
a first panel comprising a front face and a back face disposed opposite the front face, the front face having an image thereon;
a second panel connected to the first panel along the length of a fold edge separating the first panel and the second panel, the second panel comprising a front face, a back face disposed opposite the front face, and a removable perforated section; and
at least one adhesive portion, wherein the first panel is operable to be adjusted to a folded position such that the front face of the first panel substantially faces the back face of the second panel.

2. The greeting card of claim 1, wherein the at least one adhesive portion is adapted to maintain the front face of the first panel in a position substantially facing the back face of the second panel.

3. The greeting card of claim 1, wherein the at least one adhesive portion is provided on the front face of the first panel.

4. The greeting card of claim 1, wherein the at least one adhesive portion is provided on the back face of the second panel.

5. The greeting card of claim 1, wherein the at least one adhesive portion is an adhesive strip.

6. A greeting card, comprising:
a first panel comprising a front face and a back face disposed opposite the front face, the front face having an image thereon;
a second panel connected to the first panel along the length of a fold edge separating the first panel and the second panel, the second panel comprising a front face, a back face disposed opposite the front face, and a removable perforated section; and
a third panel having a front face and a back face disposed opposite the front face,
wherein the first panel is operable to be adjusted to a folded position such that the front face of the first panel substantially faces the back face of the second panel.

7. The greeting card of claim 6, wherein the third panel comprises a pivotable easel portion.

8. The greeting card of claim 7, wherein the pivotable easel portion comprises at least one perforated section.

9. The greeting card of claim 6, wherein the third panel is connected to the second panel along the length of a second fold edge separating the second panel from the third panel.

10. The greeting card of claim 6, wherein the third panel is operable to be adjusted to a folded position such that the front face of the third panel substantially faces the back face of the first panel.

11. The greeting card of claim 6, further comprising at least one adhesive portion, wherein the adhesive portion is adapted to maintain the front face of the first panel in a position substantially facing the back face of the second panel.

12. The greeting card of claim 11, wherein the at least one adhesive portion is adapted to additionally maintain the front face of the third panel in a position substantially facing the back face of the first panel.

13. The greeting card of claim 11, wherein the at least one adhesive portion is provided on at least one of the back face of the first panel and the front face of the third panel.

14. The greeting card of claim 12, wherein the at least one adhesive portion is provided on the third panel.

15. A manipulated greeting card, comprising:
a first panel comprising a front face and a back face disposed opposite the front face, the front face having an image thereon;
a second panel connected to the first panel along the length of a fold edge, the second panel comprising a front face, a back face disposed opposite the front face, and a hole therethrough, wherein the back face of the second panel substantially faces the front face of the first panel; and
a third panel having a front face and a back face disposed opposite the front face,
wherein at least a portion of the image is visible through the hole in the second panel.

16. The greeting card of claim 15, where the third panel comprises an easel portion extending therefrom.

17. The greeting card of claim 16, wherein the easel portion is adapted to support the greeting card in an upright position.

18. The greeting card of claim 15, wherein the third panel is connected to the second panel along the length of a second fold edge that separates the second panel from the third panel.

19. The greeting card of claim 15, further comprising at least one adhesive portion wherein the adhesive portion is adapted to maintain the front face of the first panel in a position substantially facing the back face of the second panel.

20. The greeting card of claim 19, wherein the at least one adhesive portion is adapted to additionally maintain the front face of the third panel in a position substantially facing the back face of the first panel.
